(19) United States
(12) Patent Application Publication
(10) Pub. No.: US 2006/0287941 A1
(43) Pub. Date: Dec. 21, 2006

(54) Unified service for auctions and classified advertisements

(75) Inventor: Phani K. Vaddadi, Issaquah, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/154,618

(22) Filed: Jun. 16, 2005

(51) Int. Cl. G06Q 40/00

(52) U.S. Cl. 705/37

(57) ABSTRACT

A system, method and data structure enabling remote users to selectively participate in electronic auctions and electronic classified advertisements. The system includes a user interface and a negotiation engine. The method includes obtaining from a first remote user a request to perform an action in connection with one or more electronic transactions and a selection from a plurality of available transaction types and then performing the requested action in connection with the electronic transactions. The data structure, which is stored on one or more computer-readable media, includes a first field containing data identifying an item and a second field containing data indicating whether the item is associated with an auction, a classified advertisement, or another form of electronic transaction.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Auctions and classified advertisements are well established methods for buying and selling items, such as products and services. Auctions are based on a bidding process, and classifieds in the print media are simply advertisements.

With the advent of the World Wide Web, online (or electronic) auction and classified services are increasing in popularity. An online auction allows multiple buyers to bid on a particular item during a predetermined time frame. Online classified advertisements allow a buyer to enter into an individual negotiation with a seller. Buyers may bid or negotiate at any time and sellers are not restricted to traditional geographic limitations of the pool of potential buyers.

Online auction and classified advertisements are segregated, with an online auction service not offering classified advertisements and vice versa. Many differences between classifieds and auctions have led to this segregation. Auction services typically entail minimal involvement by the seller, while classifieds typically involve equal participation by the buyer and seller. Further, with an auction, the highest bid wins at the time of closing. However, with classified advertisements, a buyer and seller may decide to buy or sell at anytime during negotiations. Another difference is that auction services generally have a larger pool of buyers and sellers which requires a higher degree of scalability than classifieds. These differences between online auctions and classifieds limit the options available to both buyer and seller.

### SUMMARY

The present invention overcomes the deficiencies described above by providing a system and method that combines online classified advertisements and auctions into a single, unified service. With such a service, a seller may sell products for an auction or a classified transaction within the same service, and a buyer may purchase products without limitations as to the type of transaction.

In one aspect of the present invention, a system is provided for enabling remote users to selectively participate in electronic auctions and electronic classified advertisements. The system includes a user interface operable to communicate with the remote users over a network. The user interface provides the remote users with an option to select from two or more available transaction types, including at least electronic classified advertisements and electronic auctions. The system also includes a negotiation engine operable to process transactions relating to electronic classified advertisements and operable to process transactions relating to electronic auctions.

In a further aspect of the present invention, a method is provided for facilitating electronic transactions between prospective buyers and sellers. The method includes providing a user interface to communicate with remote users over a network and obtaining over the network from at least a first remote user a request that an action be performed in connection with one or more electronic transactions. The method further includes providing a negotiation engine operable to process transactions relating to electronic classified advertisements and operable to process transactions relating to electronic auctions and obtaining over the network from the first remote user a selection from a plurality of available transaction types, including at least electronic classified advertisements and electronic auctions. Finally, the method includes performing the requested action in connection with the one or more electronic transactions.

In yet another aspect of the present invention, a data structure stored on one or more computer-readable media is provided, wherein the data structure represents an item record. The data structure includes a first field containing data identifying the item and a second field containing data indicating the item type, e.g., whether the item is an auction item or a classified advertisement item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, which are incorporated by reference herein and wherein:

FIG. 1 is a block diagram of a computing system environment suitable for use in implementing the present invention;

FIG. 2 is a flowchart illustrating an exemplary method for facilitating electronic transactions between prospective buyers and sellers in accordance with an embodiment of the present invention;

FIG. 3 is a flowchart illustrating an exemplary communication method in accordance with the embodiment of FIG. 2;

FIG. 4 is a flowchart illustrating an exemplary sign-in/sign-up method in accordance with the embodiment of FIG. 2;

FIG. 5 is a flowchart illustrating an exemplary method for adding an item in accordance with the embodiment of FIG. 2;

FIG. 6 is a flowchart illustrating an exemplary bidding method in accordance with the embodiment of FIG. 2;

FIGS. 7A and 7B are flowcharts illustrating an exemplary fulfillment method in accordance with an embodiment of FIG. 6;

FIG. 8 is a flowchart illustrating an exemplary method, which is an alternative to the method of FIG. 5, for adding an item in accordance with an embodiment of the present invention;

FIG. 9 is a block diagram illustrating an exemplary data structure containing an item identifier and an item type in accordance with an embodiment of the present invention;

FIGS. 10A and 10B are diagrams illustrating an exemplary system architecture in accordance with an embodiment of the present invention;

FIGS. 11A, 11B and 11C are diagrams illustrating an exemplary schema in accordance with an embodiment of the present invention; and

FIG. 12 is a flow diagram illustrating an exemplary method for facilitating electronic transactions between prospective buyers and sellers in accordance with an embodiment of the present invention.

### DETAILED DESCRIPTION

The present invention will be better understood from the detailed description provided below and from the accompanying drawings of various embodiments of the invention, which describe, for example, methods and systems for facilitating electronic transactions between prospective buyers and sellers by providing a unified service for electronic auctions and electronic classified advertisements. The detailed description and drawings, however, should not be read to limit the invention to the specific embodiments. Rather, these specifics are provided for explanatory purposes that help the invention to be better understood.

Having briefly described an overview of the present invention, an exemplary operating environment for the present invention is described below.

Exemplary Operating Environment

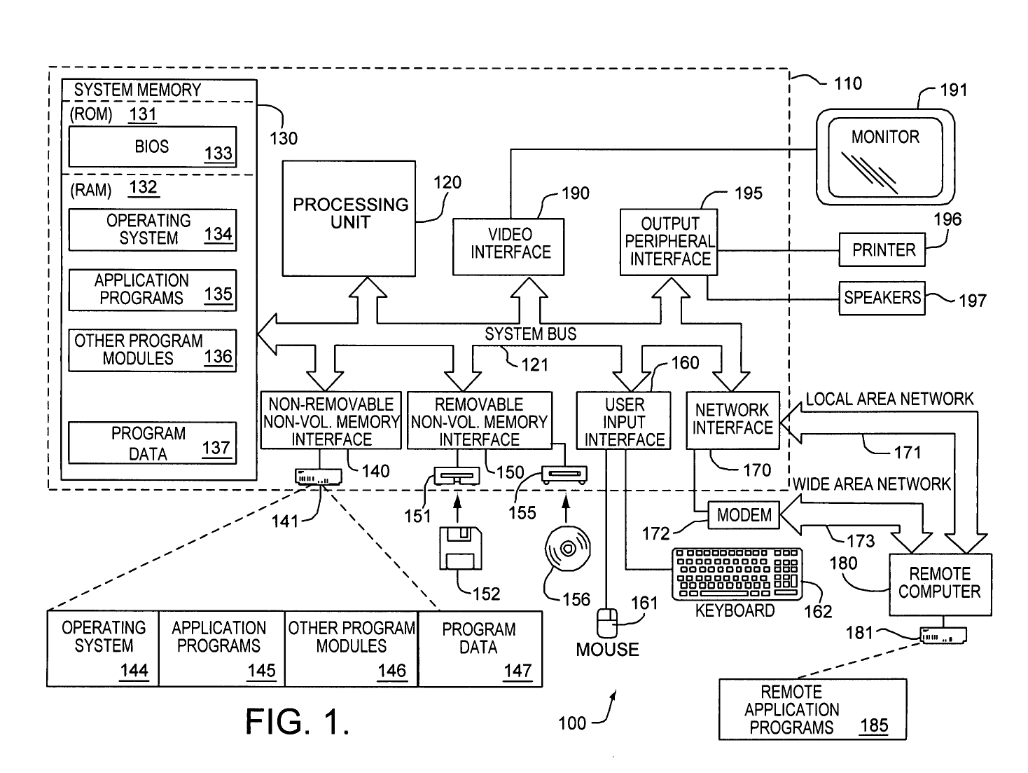

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, cellular telephones, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

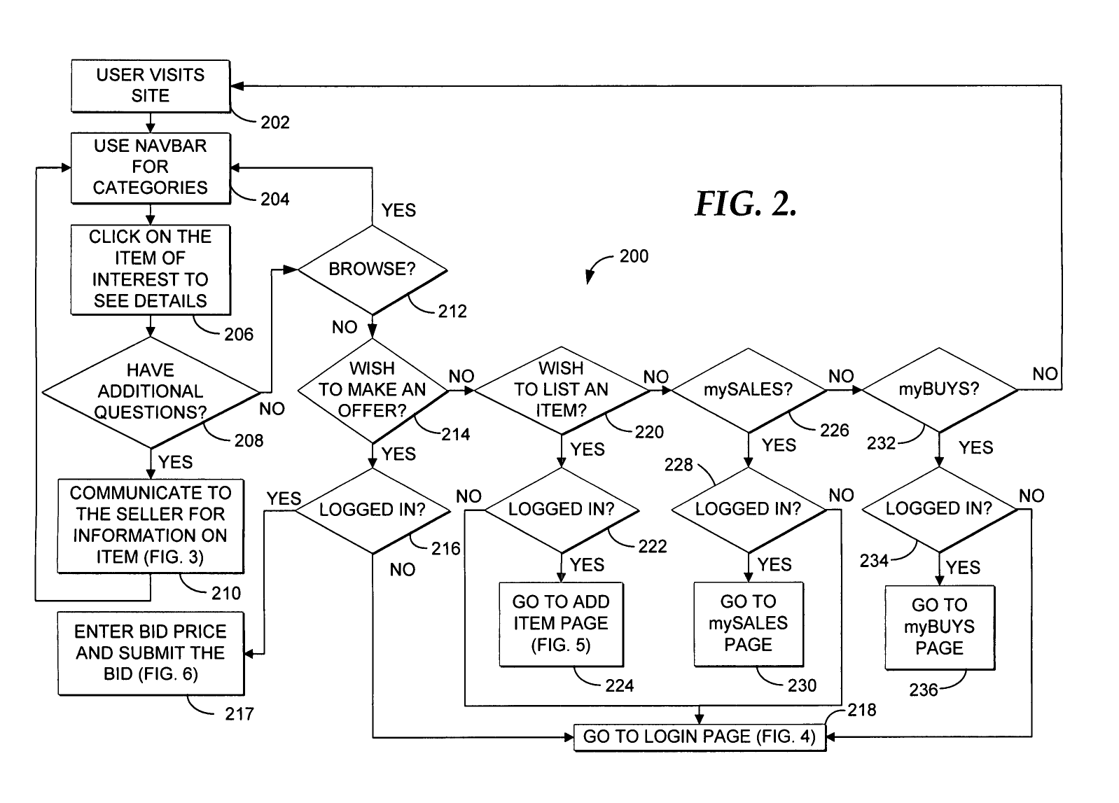

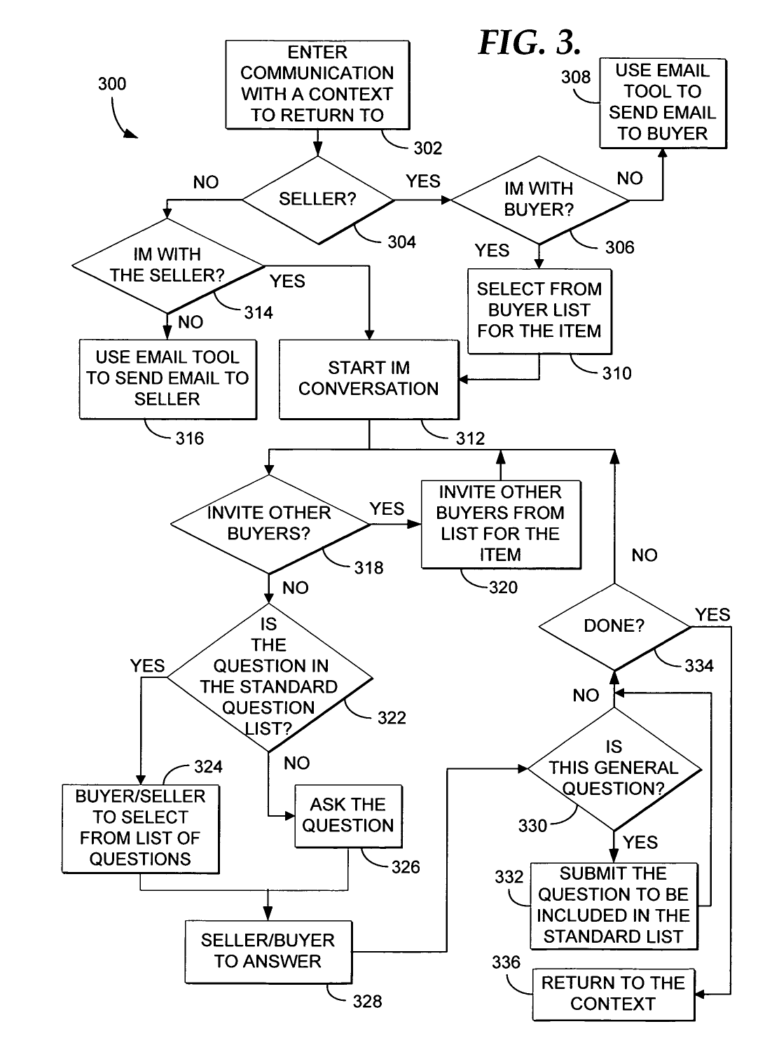

FIG. 2 is a flowchart illustrating an exemplary method 200 for facilitating electronic transactions between prospective buyers and sellers, and FIG. 2 represents the main entry point for users of the service (both buyers and sellers). The method 200 begins when a user visits the site at 202. The user may utilize a navigation bar to browse the item (e.g., product) categories at 204 and then click on an item of interest at 206 to see the item details. If the user has one or more questions at 208, the user can communicate such questions to the seller for more information on the product at 210, which is further described below in connection with FIG. 3. If the user does not have any additional questions at 208, then the user has the option at 212 to continue to browse by returning to 204.

It should be noted that the term “item”—as used herein in the context of the present invention—refers broadly to any product, service, etc. that might be listed for sale in an auction or classified advertisement. An individual instance of an “item” is referred to herein as a “unit.” For example, a seller listing three identical watches for auction has listed three units of a single item, which in this example is a product.

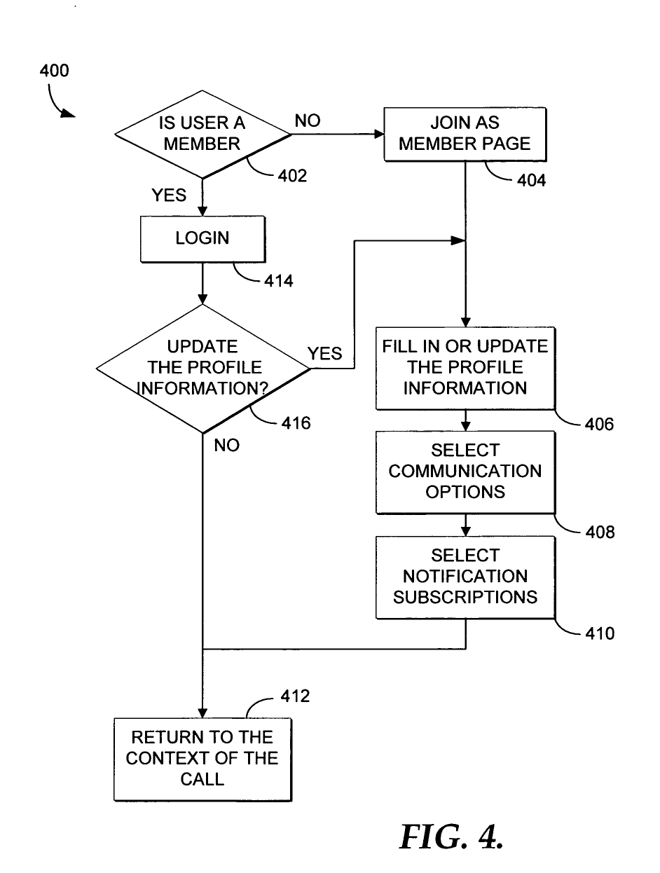

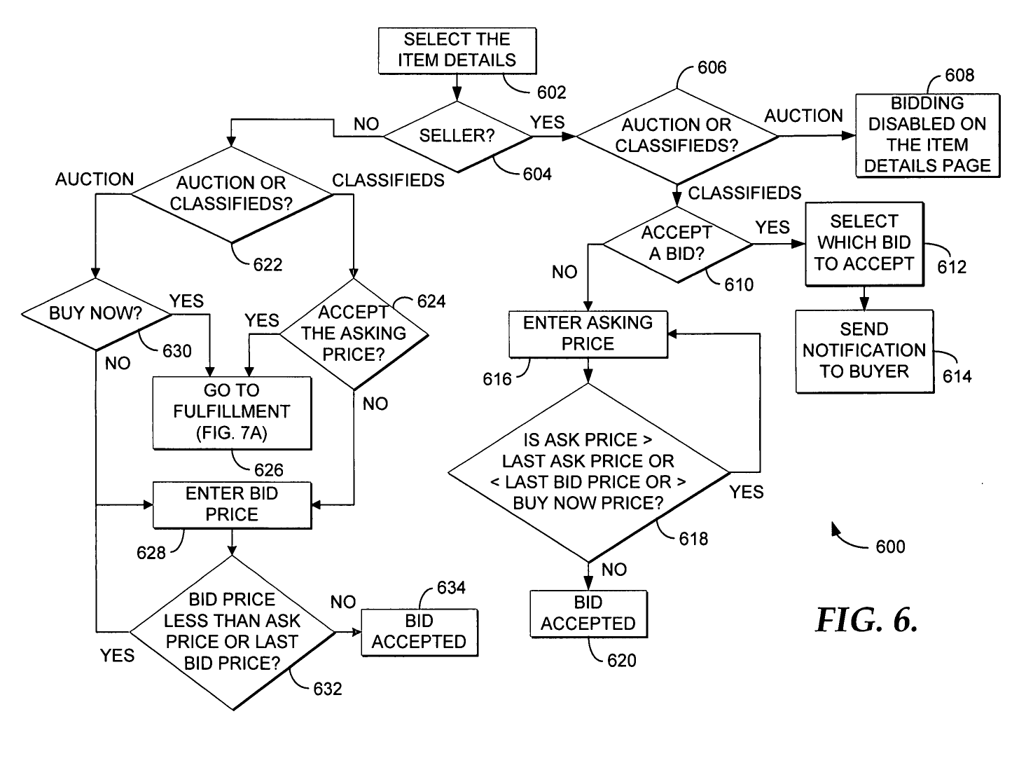

If the user chooses not to continue browsing at 212, then the user has the option at 214 of making an offer. If the user chooses to make an offer at 214, the method determines at 216 whether or not the user is logged in. If so, the user proceeds to enter a bid price and submit the bid at 217, which is further described below in connection with FIG. 6. However, if the user is not logged in, the user is sent to the login page at 218, which is further described below in connection with FIG. 4.

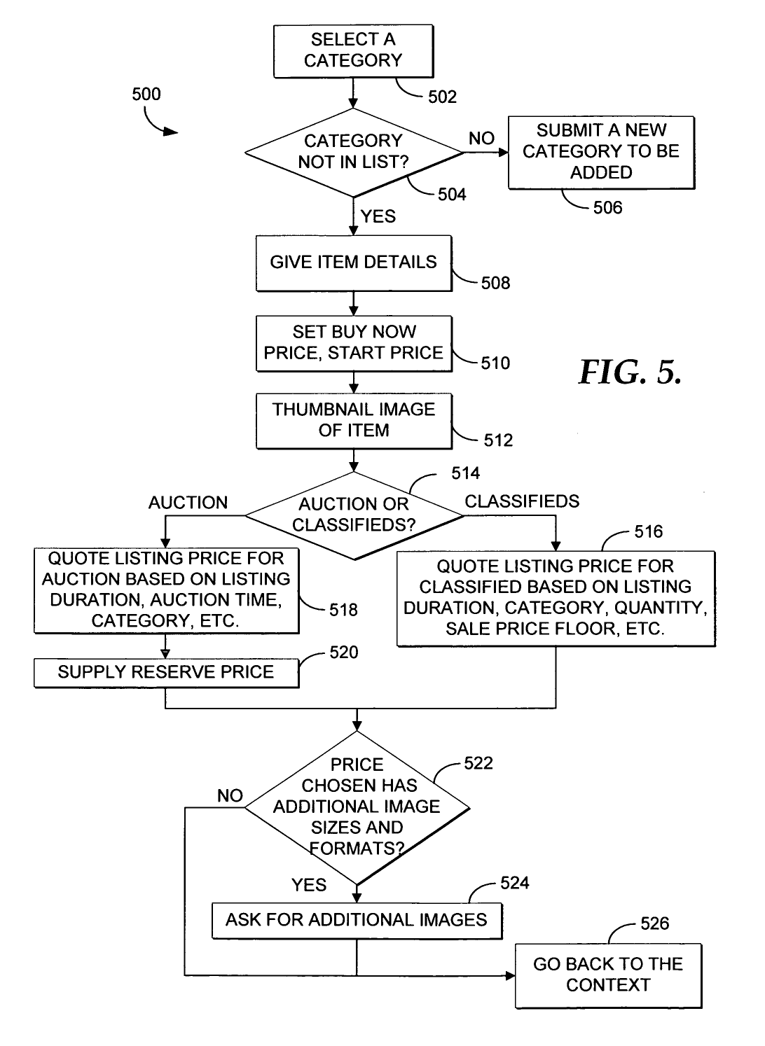

Users not wishing to make an offer at 214 can proceed to list an item at 220. Those users who wish to list an item at 220 must be logged in before proceeding to the add item page at 224, which is described below in further detail in connection with FIG. 5. If it is determined at 222 that the user wishing to list an item is not logged in, the user is sent to the login page at 218 (FIG. 4). However, users who do not wish to list an item (at 220) may visit their mySales page at 226. If the user's response at 226 is affirmative, then it is determined whether or not the user is logged in at 228. If so, the user proceeds to his or her mySales page at 230. However, if it is determined at 228 that the user is not logged in, then the user is sent to the login page at 218 (FIG. 4). However, users who do not choose to visit a mySales page (at 226) may visit their myBuys page at 232. Those users who wish to visit their myBuys page at 232 must be logged in before proceeding to that page at 236. As those skilled in the art will readily appreciate, the mySales page and the myBuys page are simply web pages customized in some manner for the particular user. In any event, if it is determined at 234 that the user is not logged in, then the user is sent to the login page at 218 (FIG. 4). Users who do not want to visit a myBuys page (at 232) can return to 202.

FIG. 3 is a flowchart illustrating an exemplary communication method 300 in accordance with the embodiment of FIG. 2. Specifically, method 300 is invoked by method 200 at 210 following a determination at 208 that the user has one or more additional questions. At 302, the user enters into the communication method 300 with a context that can be returned to at an appropriate time. It is determined at 304 whether or not the user is a seller. If so, then the seller at 306 can initiate an instant message (IM) session with a prospective buyer. If the seller chooses not to initiate an IM session with the buyer, the seller uses an email tool at 308 to send email to the buyer. Otherwise, the seller is directed to 310 to select from the buyer list for the item. Then, the IM conversation begins at 312.

When it is determined at 304 that the user is not a seller, then the method proceeds to 314 and the user can IM with the seller. If the user elects not to IM with the seller, then the user/buyer uses the email tool at 316 to send email to the seller. On the other hand, a user who chooses to IM with the seller at 314 proceeds to 312 to start the IM conversation with the seller.

Once the IM conversation starts at 312, the user can select at 318 whether or not to invite other buyers to the IM conversation. If the user chooses to do so, then the other buyers are invited at 320 from the list for the item and the method returns to 318 to determine whether yet another buyer should be invited. If no other buyers are to be invited, the method proceeds to 322 to determine whether or not the question that prompted the communication in the first place (at 208 in FIG. 2) is in the standard question list. If so, the user selects the question from the list at 324. If not, the question is asked at 326. In either case, the method proceeds to 328 so that the recipient of the question can answer. If it is determined at 330 that the question is a general one, then the question may be submitted at 332 for inclusion in the standard list. If the user indicates at 334 that he or she is done with the communication method, the user proceeds to 336 to return to the user's context. If not, then the method returns to 318 to determine whether or not to invite additional buyers.

FIG. 4 is a flowchart illustrating an exemplary sign-in/sign-up method 400 in accordance with the embodiment of FIG. 2. In particular, method 400 is invoked by method 200 at 218 following a determination at 216, 222, 228 or 234 that the user is not logged in. The method 400 first checks if the user is a member at 402. If the user is not a member, the user is directed to the join as member page at 404. Then, the method proceeds to fill in the profile information at 406, select communication options at 408, and select notification subscriptions at 410 before returning to the context of the call at 412.

By contrast, if the user is a member at 402, the method proceeds to login at 414. Next, the method prompts the user to update his or her profile information at 416. If the user chooses to update his or her profile information, then the method proceeds to update the profile information at 406, select communication options at 408, and select notification subscriptions at 410 before returning to the context of the call at 412. If the user chooses not to update his or her profile information at 416, the method proceeds directly to 412.

FIG. 5 is a flowchart illustrating an exemplary method 500 for adding an item in accordance with the embodiment of FIG. 2. More specifically, method 500 is invoked by method 200 at 224 following a determination at 222 that the user is currently logged in and wants to list an item. First, the user selects a category at 502. Then, at 504, it is determined whether or not the selected category is in the list. If not, then the method proceeds to 506 to submit a new category to be added to the list. If the selected category is in the list, then item details are provided at 508. Next, at 510, the user sets a buy now price and a start price. Preferably, a thumbnail image of the item is provided at 512.

The user is prompted at 514 to indicate whether to list the item as an auction item or a classifieds item. If the item is for a classifieds listing, then the method proceeds to 516 to obtain a listing price from the user. The listing price may be based on one or more of the following: listing duration, category, quantity, sale price floor, etc. However, if the item is for an auction listing, then the method instead proceeds to 518 to obtain a listing price from the user based on one or more of the following: listing duration, auction time, category, etc. Then, the user supplies a reserve price at 520. For both auction items and classifieds items, the method advances to 522 to determine whether the price chosen has additional image sizes and formats. If not, the method return's to the user's context at 526. Otherwise, the user is prompted for additional images at 524 before proceeding to 526.

FIG. 6 is a flowchart illustrating an exemplary bidding method 600 in accordance with the embodiment of FIG. 2. Method 600 is invoked by method 200 at 217 following a determination at 216 that the user is currently logged in and wants to make an offer on an item. First, the user selects the item details at 602. Then, the method determines at 604 whether or not the user is a seller.

If the user is a seller, the method 600 proceeds to 606 to determine whether the item is an auction item or a classifieds item. If the item is an auction item, bidding is disabled on the item details page at 608 because sellers are not allowed to bid. But if the item is a classifieds item, then the seller indicates whether he or she will accept a bid at 610. If so, the method proceeds to 612 so that the seller can select which bid to accept and then sends a notification to the buyer at 614. However, if the seller decides not to accept a bid at 610, the seller enters an asking price at 616. Next, the method 600 determines at 618 whether or not the asking price is greater than the last asking price or less than the last bid price or greater than the buy now price. If so, the seller is returned to 616 to enter a different asking price. Otherwise, the method advances to 620 and the bid is accepted.

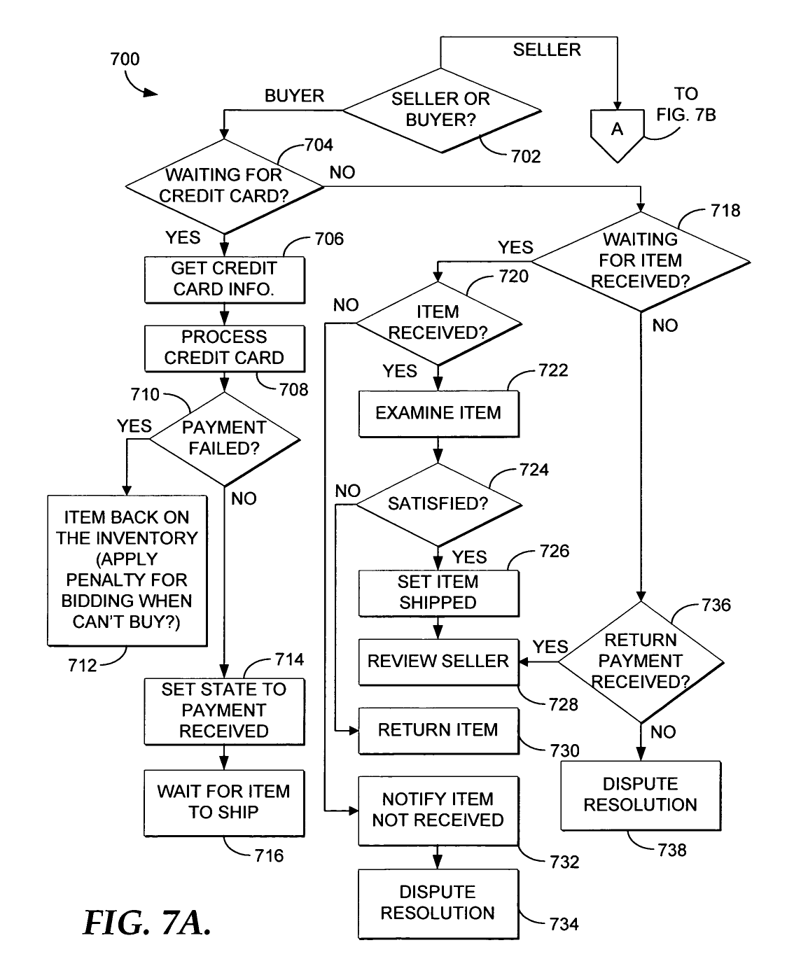

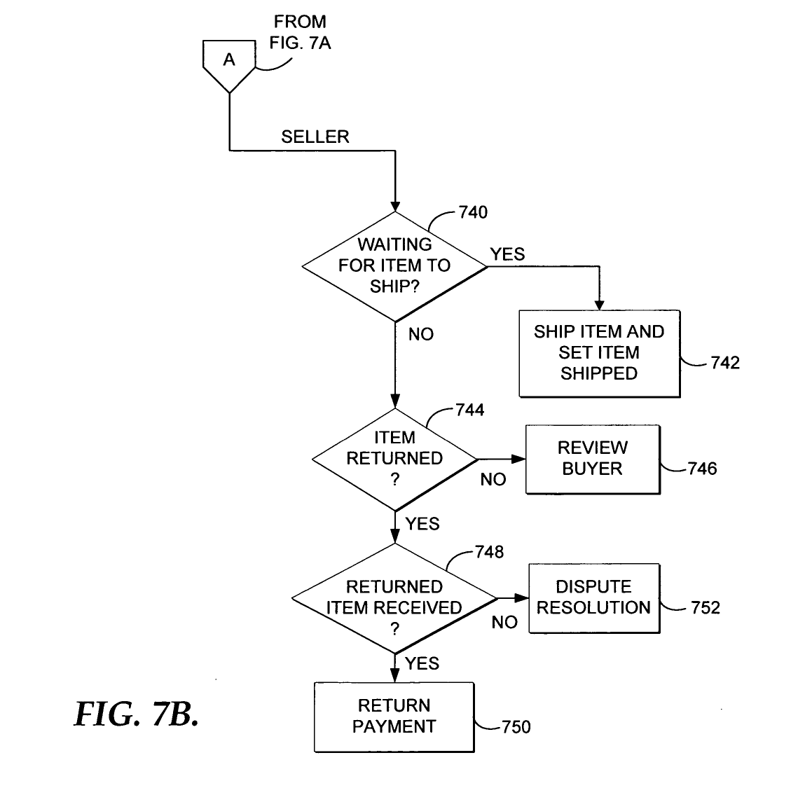

Alternatively, if it is determined at 604 that the user is not a seller, then the method 600 proceeds to 622 to determine whether the item is an auction item or a classifieds item. If the item is a classifieds item, then the user is prompted to accept the asking price at 624. If the user chooses to accept the asking price, the method proceeds to fulfillment at 626, which is further described below in connection with FIG. 7A. Otherwise, the user is prompted to enter a bid price at 628. By contrast, if it is determined at 622 that the item is an auction item, then the user is prompted to buy now at 630. If the user chooses to pay the buy now price, then the method proceeds to fulfillment at 626 (FIG. 7A). Otherwise, the user is prompted to enter a bid price at 628. For either an auction item or a classifieds item, the method 600 proceeds from 628 to 632 to determine whether or not the bid price is less than the asking price or the last bid price. If so, the method returns to 628 so that the user may enter a different bid price. Otherwise, the bid is accepted at 634.

FIGS. 7A and 7B are flowcharts illustrating an exemplary fulfillment method 700 in accordance with the embodiment of FIG. 6. Method 700 is invoked by method 600 at 626 following an affirmative indication either at 624 that the buyer will accept the asking price for a classifieds item, or at 630 that the buyer will pay the buy now price for an auction item. Method 700 may also be invoked when the buyer receives a notification that his or her bid has been accepted. In that case, there is no trigger for the buyer. Instead, the buyer responds to the notification by navigating to the site at 202 (FIG. 2). Similarly, the method 700 may be invoked when the buyer visits his or her myBuys page and sees an item awaiting a fulfillment action (e.g., providing credit card information).

Referring initially to FIG. 7A, the method first determines at 702 whether the user is a seller or a buyer. If the user is a buyer, it is determined at 704 whether the method is waiting on credit card information. If so, the method advances to 706 to get the credit card information and then to 708 to process the credit card. If it is determined at 710 that the payment has failed, the item is returned to inventory at 712 and, optionally, a penalty may be applied. However, if the payment does not fail, then the method proceeds to 714 to set the state to payment received and to 716 to wait for the item to be shipped.

With continued reference to FIG. 7A, if the determination at 704 indicates that the method is not waiting for credit card information, then the method proceeds to 718 to determine whether or not the buyer is waiting for the item to be received. If so, the method asks the buyer at 720 whether or not the item has been received. If the item has been received, then the buyer is prompted to examine the item at 722. If the examination is deemed satisfactory at 724, then the method proceeds to 726 to set the item as being shipped and to 728 to review the seller. However, if the examination is deemed unsatisfactory at 724, then the method advances to 730 to return the item. Moreover, if it is determined that the item was not received at 720, then the method issues a notification at 732 that the item has not been received and proceeds to dispute resolution at 734. If it is determined at 718 that the buyer is not waiting to receive an item, then the method proceeds to 736 to determine whether return payment has been received. If so, the buyer may review the seller at 728. Otherwise, the method proceeds to dispute resolution at 738.

In the event that the user is determined to be a seller at 702, then the method proceeds to 740 (FIG. 7B) to ask the seller whether he or she has shipped the item. If so, the method indicates that the item has been shipped at 742. If not, the method determines at 744 whether the item is being returned. If the item is not being returned, the seller may review the buyer at 746. If on the other hand the item is being returned, then the seller is asked at 748 whether or not the returned item has been received. If so, the seller provides for return payment at 750. If the returned item has not been received, the method may proceed to dispute resolution at 752.

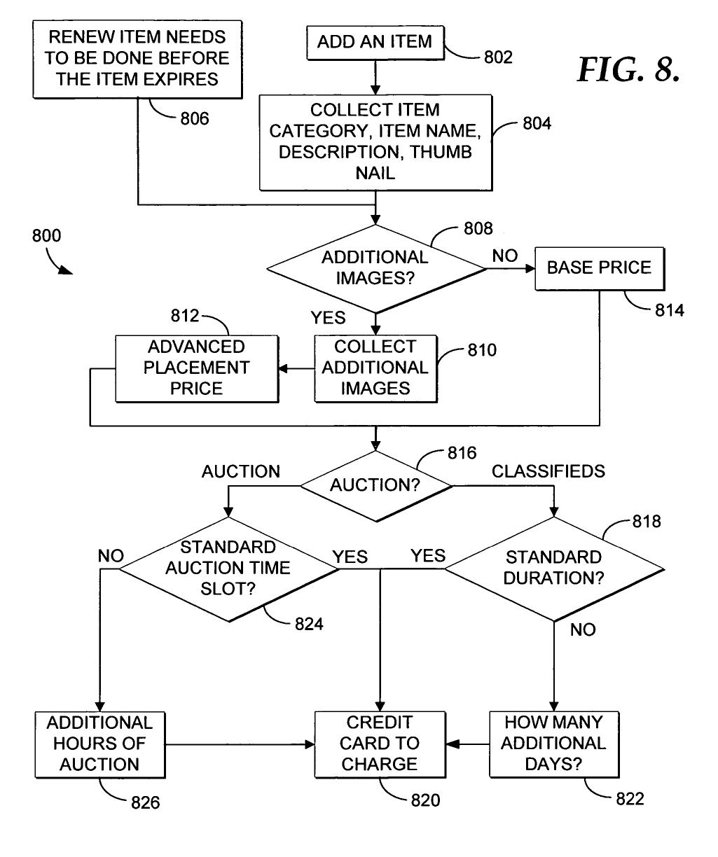

FIG. 8 is a flowchart illustrating an exemplary method 800 for adding an item, which is an alternative to the method 500 shown in FIG. 5, in accordance with the embodiment of FIG. 2. There are both differences and similarities between the methods 500 and 700. Those skilled in the art will appreciate that the decision to use either method 500, method 700, a combination of them, or some variant of one or both them is an implementation decision that will depend on the particular circumstances of the implementation.

In method 800, the user may add an item at 802, in which case the method collects the item category, item name, description and thumbnail at 804. The user may also renew an item before the item expires at 806. Upon adding or renewing an item, the user is prompted at 808 for any additional images (e.g., pictures) of the item. If so, one or more additional images are collected at 810 and an advanced placement price is determined at 812. Preferably, the advanced placement price includes the base price plus an additional listing price based on the size and number of additional images. If there are no additional images, then a base price is determined at 814. The base price can vary based on the item category, and the base price might be discounted for renewal of an existing item. As an example, a furniture item might have a base price of $2.25 with an additional listing price of $1.25 for six additional thumbnails and $0.50 for each 4×6 picture.

Upon determining a price at 812 or 814, the method advances to 816 to determine whether the item is an auction item or a classifieds item. If the item is a classifieds item, then the user is prompted whether or not to apply the standard duration for classifieds at 818. If so, the method obtains credit card information at 820 to charge the user for the listing. However, if the standard duration does not apply, the method proceeds to 822 to determine the appropriate duration, which could be more or less than the standard duration, typically measured in days. For instance, if the standard duration for classifieds is 14 days, a user could be permitted to purchase additional days (e.g., 50% additional fee for an extra seven days).

By contrast, if the item is an auction item, the method progresses from 816 to 824 to determine whether or not the standard auction time slot is applicable. If so, the method obtains credit card information at 820 to charge the user for the listing. However, if the standard time slot does not apply, the method proceeds to 826 to determine the appropriate time slot, which could be more or less than the standard time slot, typically measured in hours. For example, if the standard auction time slot is eight hours, a user could be permitted to purchase additional hours (e.g., $0.30 for each additional hour the auction remains open).

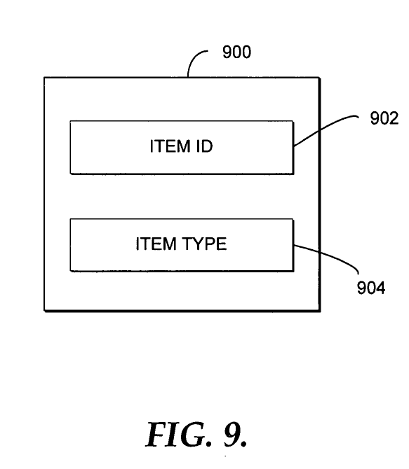

FIG. 9 is a block diagram of a data structure 900 specifying a record for an item listed for sale in connection with an electronic transaction, such as an auction or classified advertisement. The data structure 900 includes an item ID field 902 that contains information identifying a particular item. The data structure 900 also includes an item type field 904 that contains information identifying, for example, whether the item is listed as an auction item or a classified advertisement item. In one embodiment, the item type field 904 utilizes a Boolean flag to indicate whether the item is associated with an auction, a classified advertisement, or some other type of electronic transaction. The data structure 900 is stored on one or more computer-readable media.

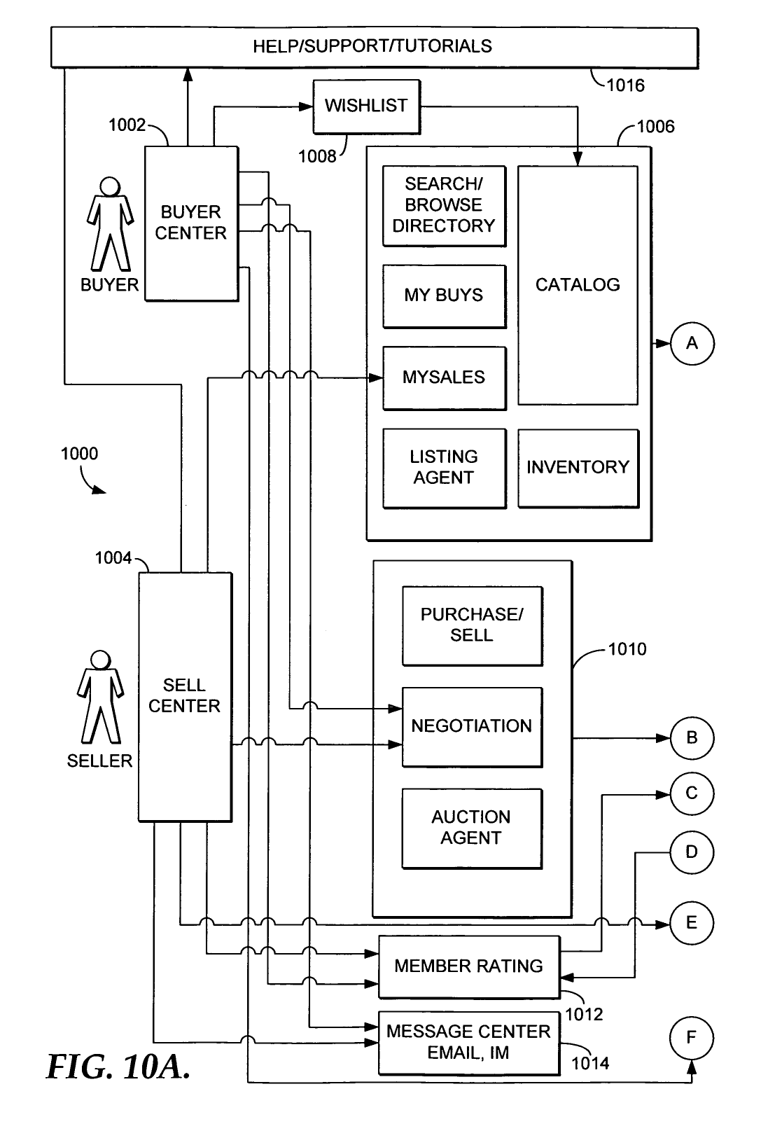

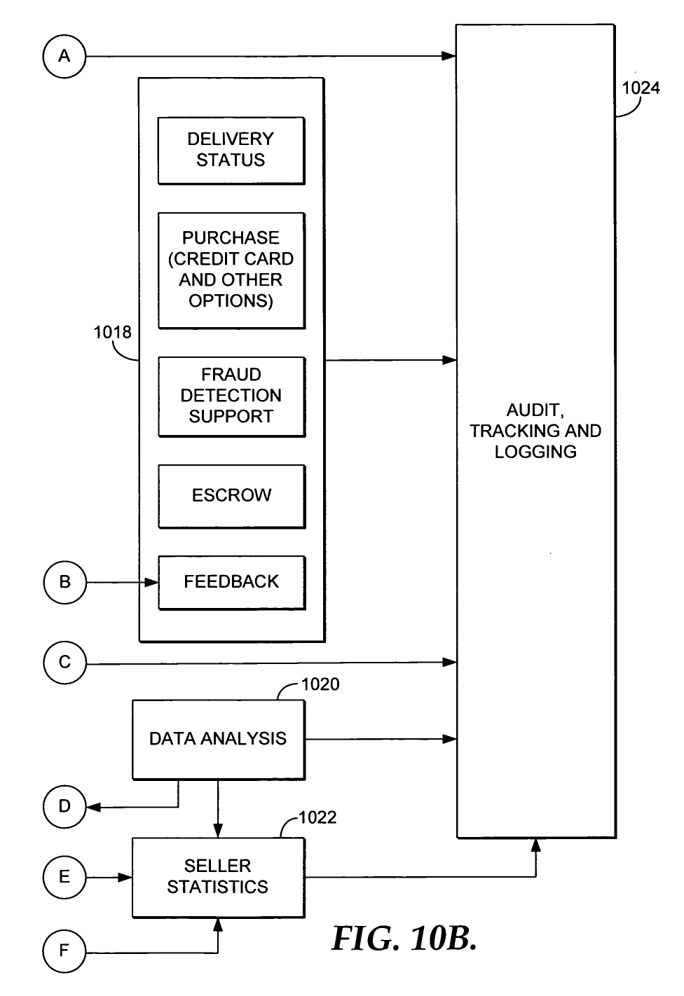

FIGS. 10A and 10B are diagrams illustrating an exemplary system architecture 1000 in accordance with an embodiment of the present invention. As shown in FIG. 10A, the system 1000 includes a buyer center 1002, a sell center 1004, a catalog module 1006, and a wishlist component 1008 located intermediate the buyer center 1002 and the catalog module 1006. The catalog module 1006 may include a number of components and sub-components, including a search/browse directory, a myBuys component, a mySales component, a listing agent, a catalog component, and an inventory component. The system 1000 also includes a transaction module 1010, a member rating component 1012, a message center 1014 and a help/support/tutorials component 1016. The transaction module 1010 may include a number of components and sub-components, such as a purchase/sell component, a negotiation engine component and an auction agent component.

Referring now to FIG. 10B, the system 1000 further includes a fulfillment module 1018, a data analysis component 1020, a seller statistics component 1022 and an audit, tracking and logging component 1024. As shown in FIG. 10B, the fulfillment module 1018 may include a number of components and sub-components, including a delivery status component, a purchase component, a fraud detection support component, an escrow component, and a feedback component. As those skilled in the art will appreciate, the flow for auctions and classifieds (described in detail above) can be identical through the various modules and components of system architecture 1000, with the exception of the transaction module 1010.

The various connections represented in FIGS. 10A and 10B may be network connections. For example, the buyer center 1002 and sell center 1004 are preferably a single, integrated user interface connected remotely over a wide area network (e.g., the Internet) to buyers and sellers at client computers, as shown for example in FIG. 1. One or more servers host the server-side modules and components of the system 1000 (e.g., catalog module 1006, transaction module 1010, fulfillment module 1018, data analysis component 1020, seller statistics component 1022, audit, tracking and logging component 1024, etc.). Alternatively, the network connecting the client and server machines could be a local area network or a metropolitan area network.

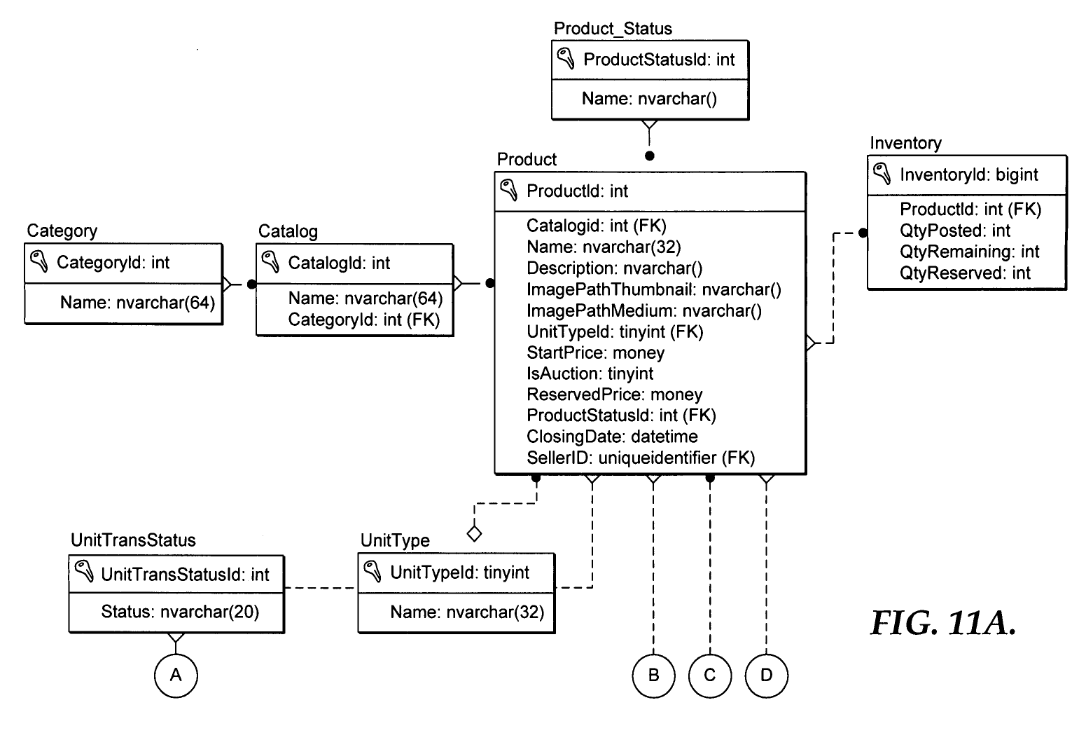

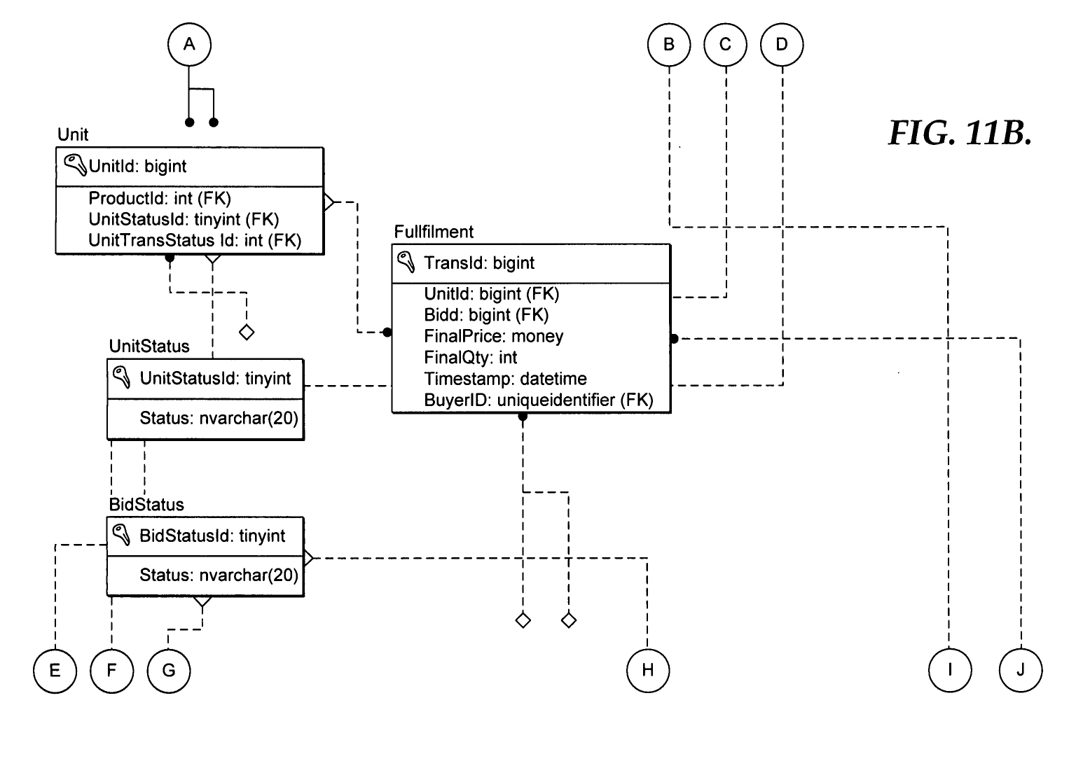

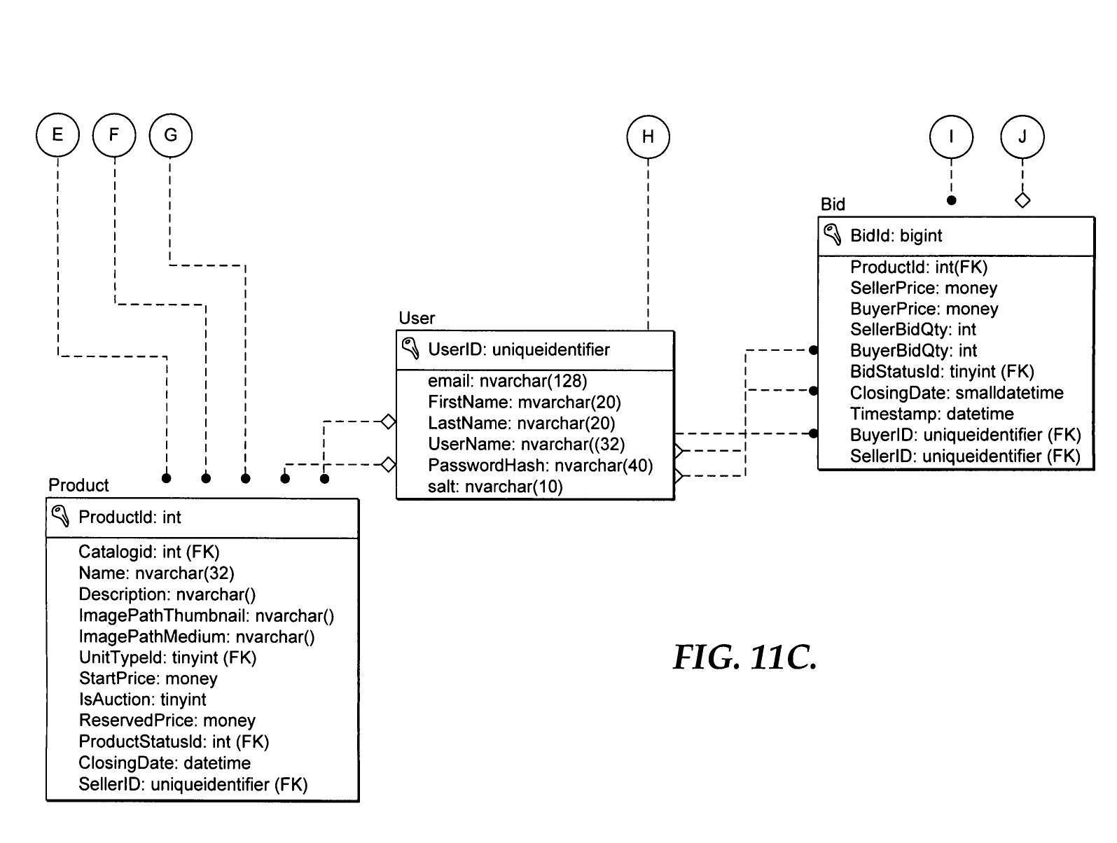

FIGS. 11A, 11B and 11C are diagrams illustrating an exemplary schema 1100 in accordance with an embodiment of the present invention. FIGS. 11A-C describe a SQL schema for use as a reference implementation. As those skilled in the art will readily appreciate, the present invention contemplates other possible reference implementations, and actual commercial implementations can vary from the reference implementation. The tables in the schema 1100 have primary and foreign key relationships so that referential integrity is maintained. Also, the tables are preferably stored in normalized form to the extent possible. The schema 1100 is compatible with general SQL standards and is specifically compatible with the SQL standards used by Microsoft Corporation of Redmond, Wash.

Because the tables in this exemplary schema are related to each other and normalized, all tables are required for all of the operations. However, some tables are used more immediately and have specific relevance to certain operations. For example, the catalog of products is stored in the following tables: Product, Product_Status, Category, and Catalog. These tables are primarily used for browsing of items, adding or listing an item, and fulfillment. The UnitTransStatus, Inventory, UnitType, Unit, and UnitStatus tables are used by most of the operations, including bidding and fulfillment. The Inventory, Fulfillment, and Bid tables are used in bidding and fulfillment. The User table contains all the user information including buyer and seller information. Whether the user is a buyer or seller is based on the foreign key to the user table (i.e., the context determines if the user is a seller or buyer for that transaction). Other operations, such as communications (FIG. 3), review of the sellers, and audit trail are not explicitly represented in the schema 1100 because they are not essential to the invention. However, those skilled in the art could readily implement such operations if desired.

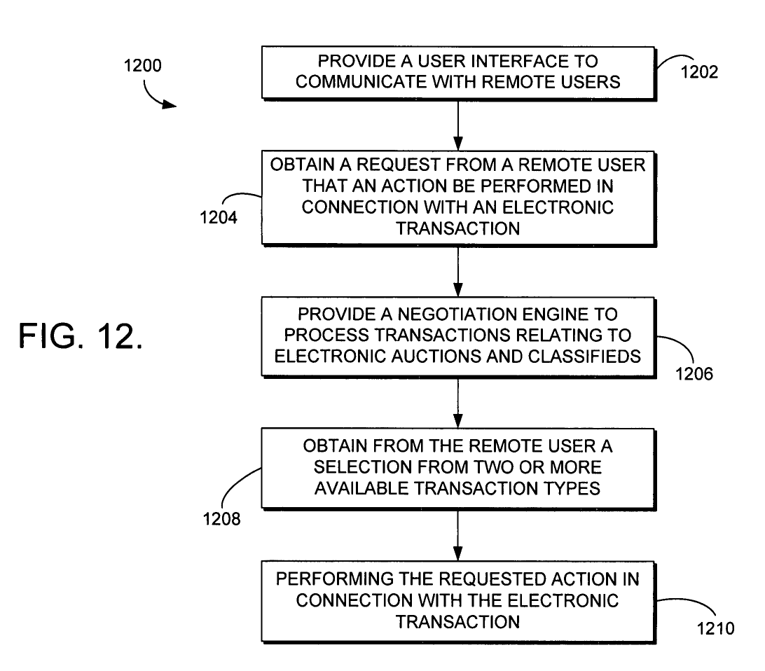

Turning to FIG. 12, a flow diagram illustrates an exemplary method 1200 for facilitating electronic transactions between prospective buyers and sellers in accordance with an embodiment of the present invention. The method 1200 provides a user interface to communicate with remote users at 1202. Preferably this user interface seamlessly presents both a buyers user interface and a sellers user interface to remote users. Further, the method 1200 obtains a request from a remote user to perform an action in connection with one or more electronic transactions at 1204. Method 1200 also provides a negotiation engine operable to process transactions relating to electronic auctions and electronic classified advertisements at 1206. The negotiation engine may also be operable to process other types of electronic transactions. Additionally, the method 1200 obtains, from the remote user, a selection from two or more available transaction types (e.g., auctions, classified advertisements) at 1208. Finally, method 1200 performs the requested action in connection with the one or more electronic transactions at 1210. The method 1200, and each of the methods disclosed herein, may be embodied in computer-useable instructions stored on one or more computer-readable media for performing the respective method.

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. For example, a user interface may be implemented with various method elements (e.g., determining whether the user is a member) in which the determination can either be made by the system, or the system can prompt the user for a response. These and other such implementation details are contemplated by the present invention, even though only a single implementation is described above. Moreover, although reference numerals, the terms “step” and/or “block”, and the like may be used herein to connote different elements of methods employed, these reference numerals and terms should not be interpreted as implying any particular order among or between the various method elements herein disclosed unless and except when the order of individual method elements is explicitly described as being required.

From the foregoing it will appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system enabling remote users to selectively participate in electronic auctions and electronic classified advertisements, the system comprising:
a user interface operable to communicate with the remote users over a network, the user interface providing the remote users with an option to select from a plurality of available transaction types, including at least electronic classified advertisements and electronic auctions; and
a negotiation engine operable to process transactions relating to electronic classified advertisements and operable to process transactions relating to electronic auctions.

2. The system of claim 1, wherein the network is at least one of a local area network, a metropolitan area network, a wide area network, and the Internet.

3. The system of claim 1, wherein a first user is a prospective buyer and a second user is a prospective seller.

4. The system of claim 1, wherein the first and second users communicate with one another via instant messaging.

5. The system of claim 1, wherein the first and second users communicate with one another via email.

6. The system of claim 3, further comprising a transactional component operable to receive payment information from the prospective buyer.

7. The system of claim 6, further comprising a statistics component, wherein the statistics component provides the prospective buyer with statistics relating to the prospective seller.

8. The system of claim 7, further comprising a catalog component, wherein the catalog component facilitates browsing a list of available items.

9. The system of claim 8, further comprising a member rating component.

10. The system of claim 9, further comprising a delivery status component.

11. One or more computer-readable media having stored thereon a data structure representing an item record for an electronic transaction service, the data structure comprising:
a first field containing data identifying an item; and
a second field containing data indicating an item type associated with the item, wherein the item type is selected by a prospective seller from a plurality of available item types, including at least an electronic auction and an electronic classified advertisement.

12. A method for facilitating electronic transactions between prospective buyers and sellers, the method comprising:
providing a user interface to communicate with remote users over a network;
obtaining over the network from at least a first remote user a request that an action be performed in connection with one or more electronic transactions;
providing a negotiation engine operable to process transactions relating to electronic classified advertisements and operable to process transactions relating to electronic auctions;
obtaining over the network from the first remote user a selection from a plurality of available transaction types, including at least electronic classified advertisements and electronic auctions; and
performing the requested action in connection with the one or more electronic transactions.

13. The method of claim 12, wherein the first remote user is a prospective seller and the requested action is listing an item.

14. The method of claim 12, wherein the first remote user is a prospective buyer and the requested action is providing the first remote user with a list of available items.

15. The method of claim 12, wherein the first remote user is a prospective buyer and the requested action is providing the first remote user with statistics relating to one or more prospective sellers.

16. The method of claim 15, wherein the statistics comprise one or more ratings.

17. The method of claim 12, further comprising confirming, to the first remote user, performance of the requested action.

18. The method of claim 12, wherein the selection indicates at least one transaction type.

19. The method of claim 12, further comprising tracking a prospective buyer with a delivery status.

20. One or more computer-readable media having computer-useable instructions stored thereon for performing the method of claim 12.
